(19) United States
(12) Patent Application Publication
(10) Pub. No.: US 2006/0163243 A1
(43) Pub. Date: Jul. 27, 2006

(54) Method of coupling fuel system components

(76) Inventors: David C. Stieler, Lake Orion, MI (US); Dale L. Sleep, Clarkston, MI (US); Brian Cheadle, Brampton (CA)

Correspondence Address: DYKEMA GOSSETT PLLC, 39577 Woodward Avenue, Suite 300, Bloomfield Hills, MI, 48304, US

(21) Appl. No.: 11/042,014

(22) Filed: Jan. 25, 2005

(51) Int. Cl. B23K 13/01

(52) U.S. Cl. 219/607; 219/609

(57) ABSTRACT

A method of coupling two or more components is provided particularly for use in joining components of a vehicle fuel delivery system. At least one of the components includes a tubular body defining a fluid passageway and is formed as a laminate having an inner metallic layer and an outer polymeric layer. In one preferred embodiment, the component includes an aluminum inner layer and a nylon outer layer. The components are joined together by generating heat through induction heat welding to cause heat transfer from the inner metallic layer to the outer polymeric layer and resulting deformation of the outer layer to form the joint.

### BACKGROUND OF THE INVENTION

1. Field of the Invention

This invention relates to methods for coupling two or more components and, in particular, to a method for coupling components of, but not limited to, a vehicle fuel delivery system and providing a fluid tight, pressurized joint.

2. Discussion of Related Art

A conventional vehicle fuel system for use with a fuel injected internal combustion engine includes a filler neck assembly, a fuel tank, fuel lines, one or more fuel rails and fuel injectors. Fuel is input to the tank through the filler neck assembly (e.g., a fuel station). Fuel is supplied from the fuel tank to the fuel rail through the fuel lines where electronically controlled fuel injectors output fuel to the combustion chambers of the engine.

Manufacturing of conventional fuel system components is an expensive and time-consuming process. Many components are formed from metal alloys such as steel (although some fuel and vapor lines have been made using plastic coated aluminum). A conventional fuel rail might have numerous components to couple together including a tubular rail, end caps, an inlet tube, mounting brackets and fuel injector cups. The brackets and cups are typically pre-staked to the tubular rail and holes are drilled through the cups. The caps, inlet tube, mounting brackets and cups are then brazed to the tubular rail. The assembly is fed through a brazing furnace to braze the various joints and is then cooled before testing, packaging and shipping. For aesthetics, corrosion resistance, and other reasons, some assembled rails are also commonly subjected to plating or the application of a protective or reflective coating. The above-described process is, again, expensive and time-consuming. The heat requirements of the brazing furnace necessitate significant energy use and precise control of temperature and furnace atmosphere conditions. The brazing process itself also typically takes a relatively high amount of time (approximately 40 minutes for one conventional fuel rail).

Hydro Aluminum Hycot USA Inc. has previously developed a nylon coated aluminum tube sold under the registered trademark “HYCOT” for use in various fluid handling applications including finished fuel lines. Further, Hydro Aluminum Hycot USA, Inc. has coupled other components to such tubes using an ultrasonic welding process. These components have been limited, however, to plastic brackets not involved in fuel transport and not requiring a fluid tight, pressurized joint.

The inventors herein have recognized a need for a method for coupling components in a fluid handling system that will minimize and/or eliminate one or more of the above-identified deficiencies. The inventors herein have particularly recognized the ability to form a fuel system component as a laminated structure such as the “HYCOT” tubing and to couple other components to that component in such a way as to form a strong, fluid tight joint that is capable of withstanding pressurized applications without the need for complex mechanical seals while simultaneously reducing the cost and time of conventional manufacturing processes such as brazing or plastic injection molding.

### SUMMARY OF THE INVENTION

The present invention relates to a method for coupling first and second components of a fluid handling system.

A method in accordance with the present invention includes the step of providing the first component, the first component including a tubular body defining a fluid passageway and formed as a laminate having an inner metallic layer and an outer polymeric layer. The component may, for example, comprise a fuel filler neck or a fuel rail. The method further includes the step of positioning the second component relative to the first component. This step may include the substep of aligning fluid apertures in the first and second components. The method further includes the step of energizing a conductor proximate the first and second components to generate heat transfer from the inner layer of the first component to the outer layer of the first component to deform the outer layer of the first component and bond the second component to the first component.

A method in accordance with the present invention has significant advantages relative to conventional manufacturing methods for fuel system components. The bonded joints for the parts of a fuel rail or other component can be formed in under one (1) minute as compared to the typical 15-40 minutes required for a furnace brazing operation. Moreover, the process does not require the significant energy use, precise control of temperature and furnace atmosphere conditions or considerable processing time of a furnace brazing operation. Further, the appearance and composition of the component eliminates the need for plating and/or painting of the component prior to shipping to the customer, since the external surfaces that are normally exposed to the ambient environment—including the bonded joint itself—are completely covered by the polymer laminate coating.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a diagrammatic view of a vehicle fuel system.

FIG. 2 is a cross-sectional view illustrating a fuel rail having components coupled together using a method in accordance with the present invention.

FIG. 3 is an enlarged view of a portion of FIG. 2.

FIG. 4 is a flow chart illustrating a method in accordance with the present invention.

### DETAILED DESCRIPTION OF EMBODIMENTS OF THE INVENTION

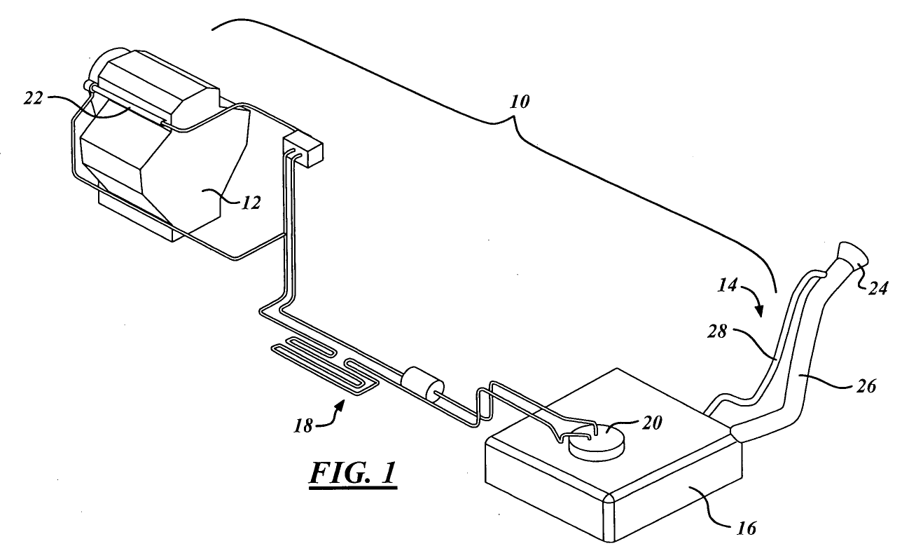

Referring now to the drawings wherein like reference numerals are used to identify identical components in the various views, FIG. 1 illustrates a vehicle fuel system 10. System 10 is particularly adapted for use in an automobile or light truck, but it should be understood that the inventive method described herein could be used for fuel systems on other types of vehicles and in a variety of fluid handling systems for vehicular and non-vehicular applications. System 10 is provided to store and transport fuel for use in internal combustion engine 12. System 10 may include a filler neck assembly 14, a fuel tank 16, fuel lines 18, a fuel pump 20, fuel rail 22 and fuel injectors (not shown).

Filler neck assembly 14 is provided to deliver fuel to the fuel tank 16. Filler neck assembly 14 may include a cup assembly 24 configured to receive a fuel nozzle, a neck 26 for transferring fuel from cup assembly 24 to fuel tank 16, and a side tube 28 to allow displaced vapors in fuel tank 16 to be vented during refueling. Filler neck assembly 14 is described in greater detail in the commonly-assigned U.S. patent application titled “Plastic Coated Metal Filler Neck Assembly” filed on Jan. 25, 2004 and naming David Stieler and Dale Sleep as inventors, the entire disclosure of which is incorporated herein by reference.

Fuel tank 16 provides a reservoir for storage of fuel. Fuel tank 16 is conventional in the art. The size and shape of fuel tank 16 may vary in accordance with design considerations for the vehicle in which fuel tank 16 is located. Fuel tank 16 is in fluid communication with neck 26 and side tube 28 of filler neck assembly 14 and supply and return fuel lines 18.

Fuel lines 18 are provided to transport fuel between fuel tank 16, pump 20 and fuel rail 22. Fuel lines 18 are conventional in the art and are generally tubular in shape. Fuel lines 18 are made from metals and metal alloys such as steel or from plastics or a combination of metals, metal alloys and plastics.

Pump 20 provides a means for causing fluid to flow within fuel system 10. Pump 20 is conventional in the art and may be disposed between fuel tank 16 and fuel rail 22, preferably in the supply fuel line.

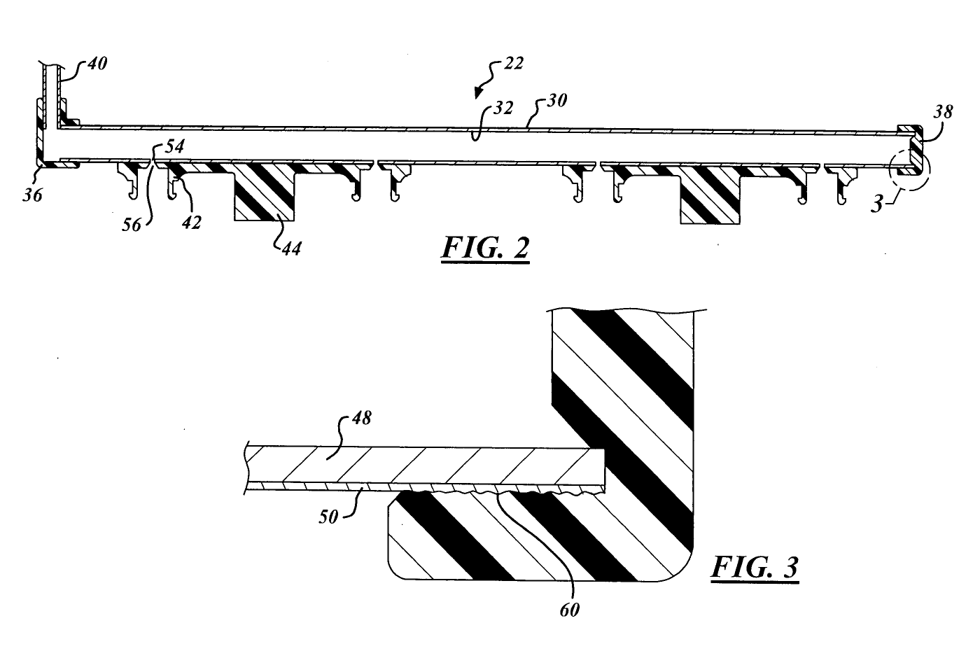

Fuel rail 22 provides a local fluid reservoir and a means for mounting of, and fuel delivery to, fuel injectors (not shown). Referring to FIGS. 2-3, rail 22 may include an elongate tubular body 30 defining a fluid chamber 32 and a plurality of fuel injector ports 34. Rail 22 may include end caps 36, 38 at either longitudinal end, an inlet tube 40 coupled to fuel line 18, fuel injector pods 42 and mounting brackets 44. Fuel rail 22 is described in greater detail in the commonly-assigned U.S. patent application titled “Plastic Coated Metal Fuel Rail” filed on Jan. 25, 2004 and naming David Stieler and Dale Sleep as inventors, the entire disclosure of which is incorporated herein by reference.

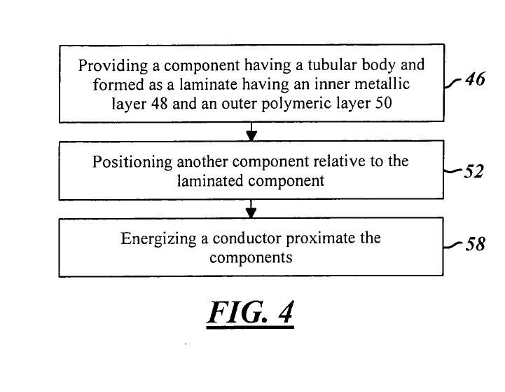

Referring now to FIG. 4, a method in accordance with the present invention is described and illustrated. The method includes the step 46 of providing a component having a tubular body and defining a fluid passageway that is formed as a laminate having an inner metallic layer and an outer polymeric layer. This component may, for example, comprise neck 26 or side tube 28 of filler neck assembly 14, fuel line 18, or body 30 of fuel rail 22. The component has a tubular body (e.g., body 30 of fuel rail 22 in FIGS. 2-3). The component defines a fluid passageway (e.g., fluid chamber 32 in body 30) in which fuel or another fluid may be stored and/or through which fuel or another fluid may be transported. Referring to FIG. 3 (illustrating a portion of body 30 of fuel rail 22), the component includes inner and outer layers 48, 50. The terms “inner” and “outer” as used herein are intended to refer to the juxtaposition of layer 48 relative to layer 50. It should be understood that additional laminate layers may be formed inwardly of inner layer 48 or between inner and outer layers 48, 50 and that either of layers 48, 50 may include a plurality of sublayers without departing from the spirit of the present invention. Inner layer 48 is metallic. Layer 48 may comprise steel. In a preferred embodiment layer 48 comprises aluminum. Outer layer 50 is polymeric and may comprise a plastic and, in particular, a thermoplastic. Outer layer 50 may or may not include a metallic or carbon or other non-metallic filler. In a preferred embodiment, outer layer 50 comprises nylon. Nylon refers to a family of polyamides generally characterized by the presence of the amide group, —CONH. In a preferred embodiment, the nylon is of a type known as nylon 12. It should be understood, however, that the type of nylon may vary and may be conductive (e.g., through the addition of carbon black) or non-conductive. Outer layer 40 may be pre-bonded to the inner layer 38 and may be extruded over the inner layer 38. In one constructed embodiment, the component is formed from nylon coated aluminum tubing sold under the registered trademark “HYCOT” by Hydro Aluminum Hycot USA, Inc. The aluminum inner layer of the tubing has a thickness of about 0.1 to about 1.2 mm. The nylon outer layer of the tubing has a thickness of between about 80 and about 500 microns and may measure about 150 microns.

Referring again to FIG. 4, the method may continue with the step 52 of positioning another component relative to the component described above. Where the first component comprises a neck 26 of assembly 14, the second component may comprise, for example, cup assembly 24, side tube 28, a grounding strap or a flexible coupling between neck 26 and tank 16. Where the first component comprises body 30 of fuel rail 22, the second component may, for example, comprise an end cap 36 or 38, inlet tube 40, a valve, a fuel injector pod 42 or a mounting bracket 44 as shown in FIGS. 2-3. As shown in FIG. 2, step 52 may include the substep of aligning fluid apertures 54, 56 in the two components for a purpose described hereinbelow.

The method may continue with the step 58 of energizing a conductor, such as a coil, proximate the two components (e.g., body 30 and end cap 38 shown in FIG. 3) in a form of induction welding. The inventors herein have recognized that the resulting electromagnetic field providing inductive energy to the inner layer 48 of the laminated component will result in heat transfer to outer layer 50 and, at sufficient levels, will result in deformation of outer layer 50 through melting. Referring to FIG. 3, this action bonds the two components by forming a joint 60 between the two components that has significant strength. In fact, testing has shown that joint 60 is stronger than even the metallic inner layer 48 of the laminated component when submitted to pressure, pull and twist forces. The joint 60 also forms a hermetic seal such that fluid handling components may have fluid inlets and outlets sealingly coupled as shown in FIG. 2 (see fluid apertures 54, 56). Although the above description referred to formation of a single joint, it should be understood that multiple joints could be formed substantially simultaneously. In particular, multiple components could be positioned in step 52 (e.g., end caps 36 and 38 relative to body 30 of fuel rail 22) and joints formed substantially simultaneously in step 58 (allowing for slight time variation in formation of the bonds for components made from different materials). Alternatively, multiple components could be joined sequentially rather than substantially simultaneously. The formation of multiple joints may involve the use of multiple conductors to create induction heat welds at multiple locations. Further, it should be understood that the components being bonded to the laminated component may be made from a variety of materials. End caps 36, 38 and pods 42 may be made from plastics, for example. Alternatively, the inventors have discovered that metallic components, and particularly aluminum components, can be bonded in the same manner. In this case, the bond integrity between the aluminum component and the laminated component may be optionally improved by preconditioning of the surfaces of the aluminum component. Suitable conditioning treatments may include chemical etching by caustic or acid solutions, or by mechanical roughening or machining, including machined features such as ridges that may promote penetration of the mating polymeric material during heating and laminate deformation. In particular, a mechanical lip or stop or radial bend may be provided which is for example, bent over or formed within the connection after or during step 58. These mechanical structures resist high pressure stresses and/or shift bending stresses away from the joint. The structure could be formed in the laminated component and received within a corresponding recess in the metallic component. The inventive method has several advantages for fitting to line connections as compared to traditionally brazed aluminum connections for use in fluid handling applications such as aluminum fuel lines or fuel cooling, air-conditioning lines, power steering lines, and engine cooling or oil cooling applications. First, the laminated tubing described herein can be used without the otherwise prohibitive temperatures involved in brazing (that would destroy the plastic coating). Second, high strength aluminum fittings (such as AA 6XXX, 5XXX or 7XXX alloys) can be used in the inventive method. These alloys are difficult to use in conventional “CAB” or Nocolok™ fluoride salt flux type brazing (whether furnace, flame or induction brazing) because the process limits the addition of Magnesium strengthening additions in the aluminum alloy that otherwise poison the flouride flux, or the temperature limits of the alloy (7xxx for example) are to low for conventional brazing.

A method in accordance with the present invention has significant advantages relative to conventional manufacturing methods for fuel system components. The joints 60 formed by the inventive method are formed rapidly-typically in under one (1) minute as compared to the typical 15-40 minutes required for a brazing operation. The inventive method also does not require the significant energy use, precise control of temperature and furnace atmosphere conditions or considerable processing time of a furnace brazing operation. Further, the appearance and composition of the component eliminates the need for plating and/or painting of the component prior to shipping to the customer, since the external surfaces that are normally exposed to the ambient environment—including the bonded joint itself—are completely covered by the polymer laminate coating.

While the invention has been shown and described with reference to one or more particular embodiments thereof, it will be understood by those of skill in the art that various changes and modifications can be made without departing from the spirit and scope of the invention.

We claim:

1. A method of coupling first and second components of a fluid handling system, comprising the steps of:
providing said first component, said first component including a tubular body defining a fluid passageway and formed as a laminate having an inner metallic layer and an outer polymeric layer;
positioning said second component relative to said first component; and,
energizing a conductor proximate said first and second components to generate heat transfer from said inner layer of said first component to said outer layer of said first component to deform said outer layer of said first component and bond said second component to said first component.

2. The method of claim 1 wherein said first and second components are components of a fuel delivery system.

3. The method of claim 2 wherein said first component comprises a fuel filler neck.

4. The method of claim 2 wherein said first component comprises a fuel rail.

5. The method of claim 1 wherein said second component comprises an aluminum component.

6. The method of claim 1 wherein said inner layer comprises steel.

7. The method of claim 1 wherein said inner layer comprises aluminum.

8. The method of claim 7 wherein said outer layer comprises nylon.

9. The method of claim 1 wherein said outer layer comprises nylon.

10. The method of claim 1 wherein outer layer is directly adjacent said inner layer.

11. The method of claim 1 wherein outer layer is extruded over said inner layer.

12. The method of claim 1 wherein said positioning step includes the substep of aligning fluid apertures in said first and second components.

13. The method of claim 1, further comprising the step of positioning a third component relative to said first component wherein said energizing step bonds said third component to said first component substantially simultaneous with said bonding of said second component to said first component.
